(19) United States
(12) Patent Application Publication
(10) Pub. No.: US 2002/0167470 A1
(43) Pub. Date: Nov. 14, 2002

(54) Mouse with data-transmission function

(75) Inventor: Kuei-Lin Chung, Taipei Hsien (TW)

Correspondence Address: DOUGHERTY & TROXELL, SUITE 1404, 5205 LEESBURG PIKE, FALLS CHURCH, VA, 22041, US

(73) Assignee: ARESON TECHNOLOGY CORP.

(21) Appl. No.: 09/851,117

(22) Filed: May 9, 2001

(51) Int. Cl. G09G 5/08

(52) U.S. Cl. 345/63

(57) ABSTRACT

A mouse is internally provided with a data processor for the mouse to read data stored in a memory card, and an I/O interface for connecting the data processor to a microcontroller in the mouse. The microcontroller is connected to a coordinate output circuit normally provided in a mouse, and to a computer via a Universal Serial Bus (USB) interface. Whereby, the mouse not only functions like a normal mouse, but also enables direct data transmission between a memory card and a computer via the mouse without the need of an external data processor. The mouse also facilitates access of data having middle to small volume from a computer and storage of the accessed data into a memory card that is portable to any place for use. High-volume compact discs and expensive apparatus for such purpose, such as recording machine, CD-ROM, MO, etc., could be saved.

### BACKGROUND OF THE INVENTION

The present invention relates to a mouse with data-transmission function, and more particularly to a mouse having a data processor for reading data stored in a memory card and a Universal Serial Bus I/O interface for connecting a microcontroller of the mouse to a computer, so that data could be conveniently transmitted between the memory card and the computer via the mouse, allowing frequently used data to be stored in the portable memory card for use at any place.

Generally, a personal data assistant (PDA) or a digital camera uses a memory card to record and/or store word and/or image data. A user could read or use the data record and/or stored in the memory card only through the PDA or the digital camera. In other words, when a user wishes to use the data in the memory card at a computer or a portable computer, it is necessary to connect the PDA or the digital camera directly to the computer and then cause the PDA or the digital camera to transfer the data in the memory card to the computer for use by a user at the computer. For most users, such procedures are complicate and inconvenient.

In the case the PDA or the digital camera is not used as a tool to transfer the data in the memory card thereof to a computer, a separate data processor would be needed to read the data in the memory card and transmit the read data to the computer for use. Disadvantages of such separate data processor include its expensive price and its occupation of additional space among other peripheral equipment.

Another problem that is currently faced by general consumers concerns a data access device. General word and/or image data has middle to small volume from about 10 MB to about 60 MB. To access such data having middle to small volume, a 3.5″ diskette would be too small in volume while a general compact disk (CD) would be too big in volume and cause unnecessary waste. Moreover, in the case of using a CD to access word and/or image data from a fixed storage means for the data to be conveniently portable, a user would have to purchase other necessary apparatus, such as recording machine, CD-ROM, MO (magneto optical). That is, there is not a convenient and economical way, at least for the time being, for general consumers to access data of middle to small volume from about 10 MB to about 60 MB, which is very common in audio-video market, so that such data could be easily portable for use at any place.

It is therefore tried by the inventor to develop a mouse that helps to solve the above-mentioned problems with the transfer of data from a PDA or a digital camera to a computer and with the device for accessing data having middle to small volume.

### SUMMARY OF THE INVENTION

A primary object of the present invention is to provide a mouse having a data processor mounted thereto, so that data transmission and access between a memory card and a computer could be easily effected simply through the mouse.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a mouse according to a first embodiment of the present invention;

FIG. 2 is an exploded perspective view of the mouse of FIG. 1 showing the insertion of a memory card thereinto;

FIG. 3 is a perspective view of a mouse according- to a second embodiment of the present invention;

FIG. 4 shows the insertion of a memory card into the mouse of FIG. 3; and

FIG. 5 is a block diagram showing the circuitry of the mouse of the present invention.

### DETAILED DESCRIPTION OF THE PREFERRED EMBODIMENTS

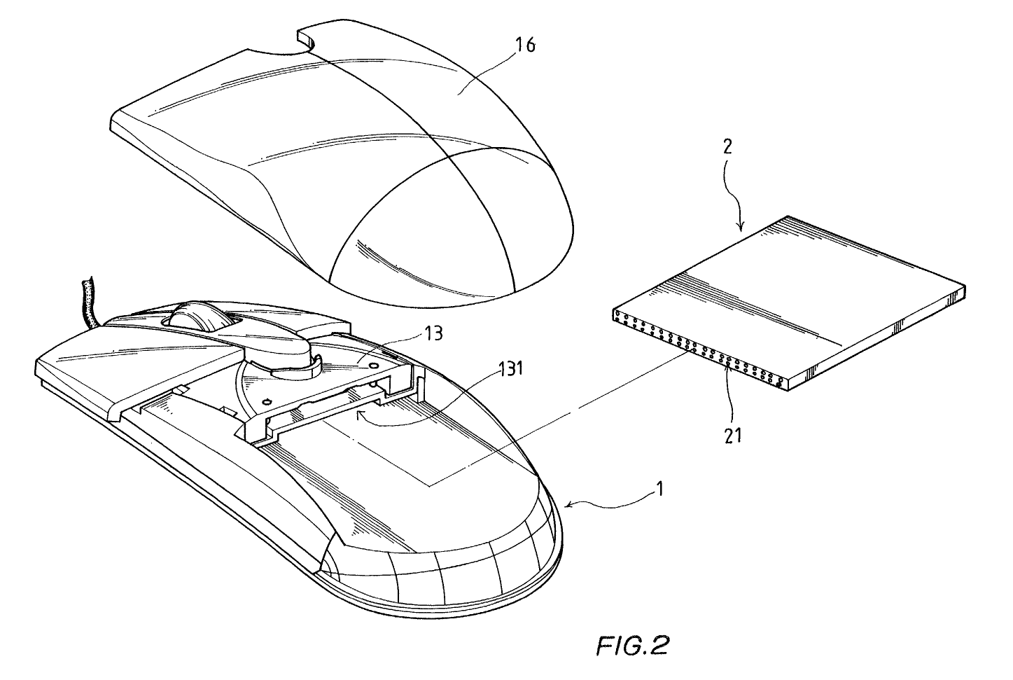

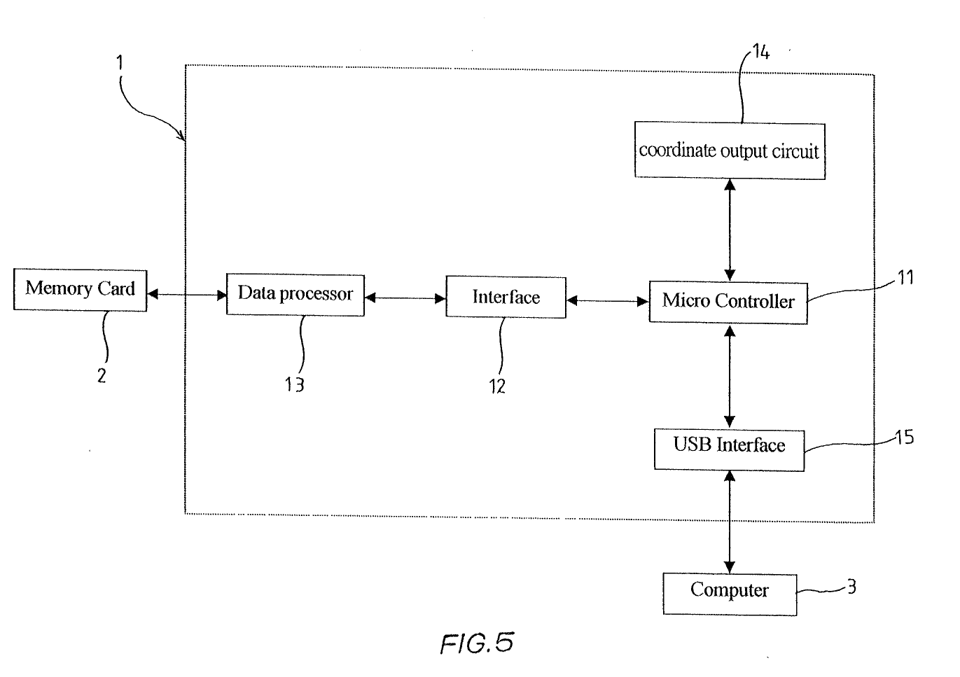

Please refer to FIG. 2 that is an exploded perspective view of a mouse 1 according to a first embodiment of the present invention, and to FIG. 5 that is a block diagram showing the circuitry of the mouse 1. As shown, the mouse 1 mainly includes a microcontroller 11, an I/O interface 12, a data processor 13, a coordinate output circuit 14, and a USB (Universal Serial Bus) I/O interface 15.

The microcontroller 11 is used to control an internal circuitry of the mouse 1.

The I/O interface 12 is connected to the microcontroller 11 for transmitting data.

The data processor 13 is mounted in the mouse 1 at an upper part thereof without influencing a ball system or optical system provided at a lower part of the mouse 1. The data processor 13 includes at least a card slot 131 having a straight opening. The card slot 131 is provided therein with attachment means corresponding to a memory card 2, so that the memory card 2 could be smoothly inserted into the card slot 131 via the straight opening thereof to electrically connect to the mouse 1. The data processor 13 is also integrally connected to the I/O interface 12 so as to read data in the memory card 2.

The coordinate output circuit 14 is connected to the microcontroller 11 for outputting a moving coordinate or a selection signal selected or made through the mouse 1.

The USB I/O interface 15 is connected to the microcontroller 11 and a computer 3, so that data read by the data processor 13 from the memory card 2 and the moving coordinate and/or the selection signal from the coordinate output circuit 14 could be transmitted to the computer 3 via the USB I/O interface 15, and data in the computer 3 could be accessed and read by the data processor 13 before being stored in the memory card 2.

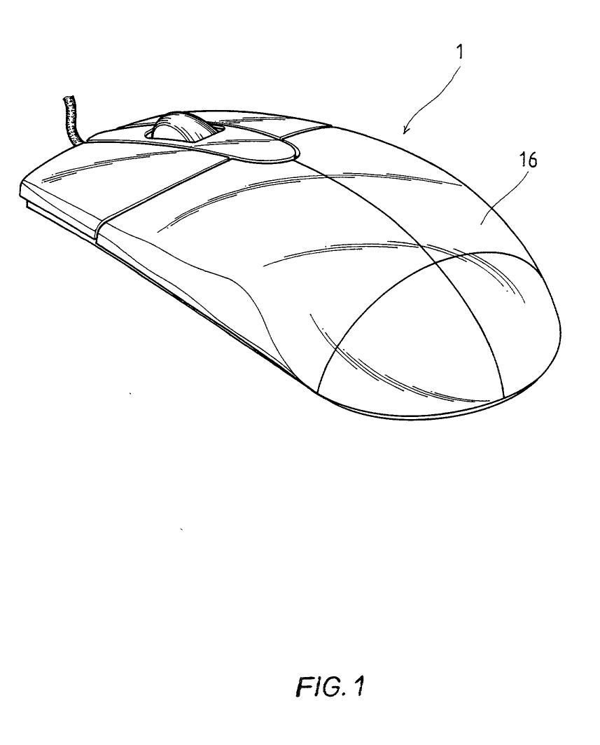

Please refer to FIGS. 1 and 2. In the first embodiment of the present invention, the data processor 13 and the card slot 131 are provided inside the mouse 1. To facilitate insertion of the memory card 2 into the card slot 131, the mouse 1 has a rear upper cover 16 that could be easily lifted open and closed.

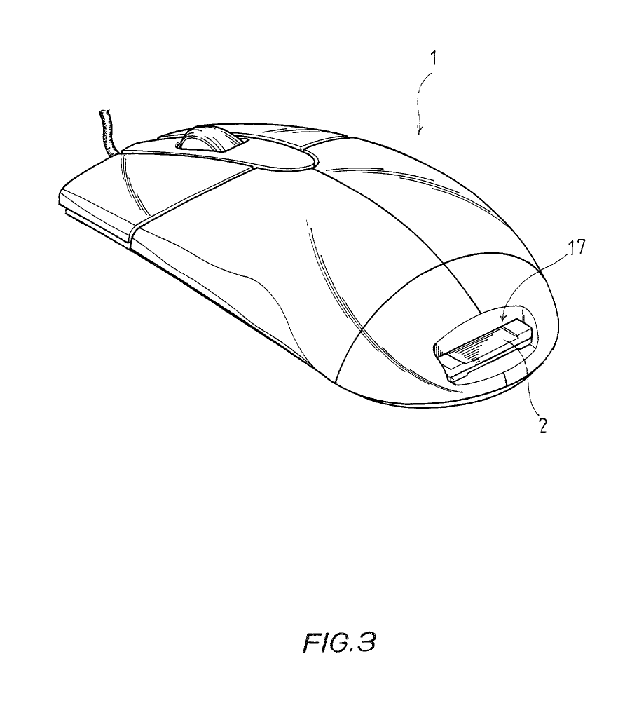

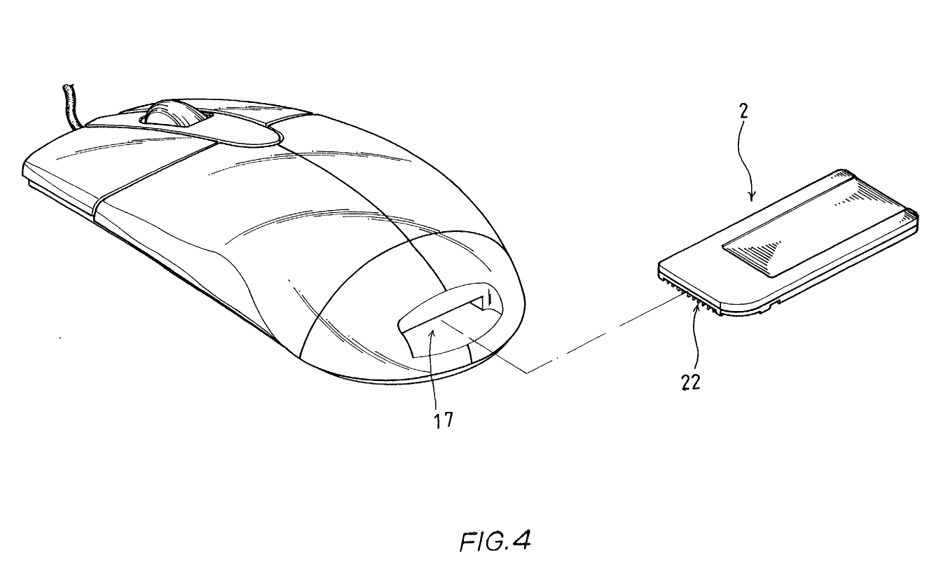

FIGS. 3 and 4 are assembled and exploded perspective views, respectively, of a mouse 1 according to a second embodiment of the present invention. In this second embodiment, the mouse 1 is provided at its rear upper cover 16 with an externally accessible opening 17 corresponding to the card slot 131 of the data processor 13 inside the mouse 1. It is preferable the opening 17 faces rearward. In this case, the memory card 2 may be directly inserted into the card slot 131 via the opening 17 without the need of lifting and closing the rear upper cover 16 of the mouse 1.

Since the currently commercially available memory cards 2 are not uniform in their specifications and dimensions, the attachment means in the card slot 131 for electrically connecting the memory card 2 to the data processor 13 are not uniform, either. The memory card 2 illustrated in FIG. 2 is provided with a plurality of pin holes 21 while the memory card 2 illustrated in FIG. 4 is provided with a plurality of conductive strips 22. Thus, the specification and dimension of the card slot 131 and the attachment means provided therein must be designed corresponding to the memory card 2 to be used with the mouse 1.

With the above arrangements, a user may insert a memory card 2 for a PDA or a digital camera into the data processor 13 in the mouse 1 for the data processor 13 to read data recorded or stored in the memory card 2. Since the mouse 1 has already been connected to the computer 3, word and/or image data recorded or stored in the memory card 2 read by the data processor 13 could be transmitted via the I/O interface 12 to the microcontroller 11, from where the transmitted data is sent to the USB I/O interface 15 and then to the computer 3. That is, the computer 3 could directly read data in the memory card 2 without the need of connecting the PDA or the digital camera to the computer 3.

On the other hand, data in the computer 3 may also be transmitted to the microcontroller 11 via the USB I/O interface 15. Data received by the microcontroller 11 from the computer 3 is then transmitted via the I/O interface 12 to the data processor 13 at where data from the computer 3 is recorded or stored into the memory card 2.

Moreover, the moving coordinate or the selection signal output by the coordinate output circuit 14 of the mouse 1 is also sent to the microcontroller 11, from where the received signal is sent to the computer 3 via the USB I/O interface 15. That is, the mouse 1 could still perform its normal function as a mouse.

Signals from the data processor 13 and the coordinate output circuit 14 to the microcontroller 11 are processed and output to the USB I/O interface 15 in receiving sequence. Thus, it is possible to operate the mouse 1 and to read data in the memory card 2 at the same time.

In the event data of middle to small volume from about 10 MB to about 60 MB is to be accessed, a user may use the mouse 1 to conveniently access the data from the computer 3 and store the accessed data in the memory card 2, so that the data could be carried to any desired place for use. The user needs not to use a high-volume compact disc to record or store the data having only middle to small volume. Other expensive apparatus, such as recording machine, CD-ROM, MO, etc., can be saved, too.

What is claimed is:

1. A mouse with data-transmission function, comprising:
a microcontroller for controlling an internal circuitry of said mouse;
an I/O interface connected to said microcontroller for transmitting data to and from said microcontroller;
a data processor being mounted inside said mouse at an upper part thereof and connected to said I/O interface, said data processor including a card slot having a straight opening, said card slot being provided therein with attachment means corresponding to a memory card, so that said memory card could be inserted into said card slot via said straight opening to electrically connect to said data processor, allowing said data processor to read data stored in said memory card;
a coordinate output circuit being connected to said microcontroller for outputting a moving coordinate or a selection signal of said mouse; and
a Universal Serial Bus (USB) I/O interface for connecting said microcontroller to a computer, so that data read by said data processor from said memory card and said moving coordinate and/or said selection signal output from said coordinate output circuit could be sent from said data controller to said computer via said USB I/O interface, and that data stored in said computer could be accessed and sent to said data processor for recording or storing into said memory card.

2. The mouse with data-transmission function as claimed in claim 1, wherein said mouse has a rear upper cover that could be lifted open for insertion of said memory card into said card slot inside said mouse.

3. The mouse with data-transmission function as claimed in claim 1, wherein said mouse has a rear upper cover that is provided with an externally accessible slot corresponding to said card slot inside said mouse, so that said memory card could be directly inserted into said card slot via said externally accessible slot.
